(19) United States
(12) Patent Application Publication
(10) Pub. No.: US 2019/0061872 A1
(43) Pub. Date: Feb. 28, 2019

(54) Dynamic Electric Drive Control

(71) Applicants: Britt Jackson, Santa Monica, CA (US); Thomas Boyle, Las Vegas, NV (US)

(72) Inventors: Britt Jackson, Santa Monica, CA (US); Thomas Boyle, Las Vegas, NV (US)

(21) Appl. No.: 16/081,117

(22) PCT Filed: Mar. 3, 2017
(86) PCT No.: PCT/US17/20712

§ 371 Date: Aug. 30, 2018

Related U.S. Application Data
(60) Provisional application No. 62/302,945, filed on Mar. 3, 2016.

(51) Int. Cl. B62M 6/65; B62M 6/45; B60K 1/02; B60K 17/04; B60K 7/00; B60L 15/20

(52) U.S. Cl. CPC B62M 6/65; B60L 2240/429; B60K 1/02; B60K 17/043; B60K 7/0007; B60L 15/2036; B60K 2007/0046; B60K 2007/0061; B60L 2200/12; B60L 2240/12; B60L 2240/14; B60L 2240/421; B60L 2240/425; B60L 2240/427; B62M 6/45

(57) ABSTRACT

A Light Electric Vehicle (LEV) 10, 20 includes two motors 24a, 24b and independent control of each motor. The two motors have different drive ratios (for example, gearing 26 or pulley/sprocket 28 ratios) or different efficiency versus RPM curves and are controlled to provide efficient operation over a wider speed range than possible with a single motor or two motors having the same efficiency at any given vehicle speed.

### CROSS-REFERENCE TO RELATED APPLICATIONS

The present application claims the priority of U.S. Provisional Patent Application Ser. No. 62/302,945 filed Mar. 3, 2016, and PCT Application Serial No. PCT/US17/20712 filed Mar. 3, 2017, which applications are incorporated in their entirety herein by reference.

### TECHNICAL FIELD

The present invention relates to electric vehicles and in particular to efficient control of electric vehicle motors.

### BACKGROUND ART

Known Light Electric Vehicles (LEVs) are two, three or four wheel vehicles which are generally lower in speed and load capability than full size Electric Cars or Trucks. LEVs include electric bikes, scooters, tricycles and small 4 wheel vehicles designed for non-highway use. Given the limited energy density of known batteries, obtaining maximum efficiency from the vehicle's propulsion system is essential with this class of vehicles. Also, given the nature of the market for these vehicles, price sensitivity is extremely high for all components.

Most LEVs use either in-wheel hub motors or simple motors connected by belt or chain to a wheel or wheels. The limitation of such motors is that they exhibit an efficiency curve which demonstrates poor efficiency at low RPM. An example of torque, power, and efficiency curves for a Permanent Magnet Direct Current (PMDC) motor is shown in FIG. 1. As a result, when LEVs operate over a wide RPM operating range, substantial time is spent at low efficiencies.

Additionally, most LEV motor controllers are set up such that when a user increases the throttle setting, the controller will supply higher voltage thus increasing the motor speed. However, as load also increases, the controller supplies more amperage until it reaches the maximum amperage supported by system components, thus amperage can become a limiting factor. Under heavy loads (either cargo, slope or wind resistance) the only real option is to inefficiently pump amperage into the system. Unfortunately, increasing amperage creates heat which wastes energy. While it is possible to increase the power rating of the motor or battery to mediate this inefficiency under load, some jurisdictions have specific limitations on the rated power of the LEV drive system.

Also, different classifications of motors provide different strengths related to the performance of an LEV. For example, a “geared” motor runs at a higher RPM, and uses a gearbox to step down to an appropriate RPM to match the vehicle speed. A geared motor is generally better at delivering start-up torque. However, the low speed efficiency of a geared motor compromises efficiencies at the higher speeds required by the application. A gearless “direct drive” motor operates at high efficiency at RPMs more compatible with LEV speeds, but provides less start-up torque. Creation of a single motor which provides low speed torque and high speed efficiency is either impossible or costly.

The market has tried multiple means of addressing these issues. There are electronic methods for “slipping” the efficiency curve across the RPM range during vehicle use. There are systems which add a multi-speed transmission to the motor and others that run a motor into a conventional transmission such as a bicycle derailleur. Each of these add cost, complexity, and failure modes and have limitations specific to their application.

Adding additional motors has been widely attempted in the LEV industry. Generally, front and rear hub motors are used to balance the traction and to add power in cases where one motor was limited in top power. While this does provide “post-traction” it ultimately multiplies the inefficiencies of single motors.

### DISCLOSURE OF THE INVENTION

The present invention addresses the above and other needs by providing a Light Electric Vehicle (LEV) including two motors and independent control of each motor. The two motors have either different drive ratios (e.g., gear ratios) or different efficiency versus RPM curves and are independently controlled to provide efficient operation over a wider speed range than possible with a single motor, or two motors having the same efficiency at any given vehicle speed.

In accordance with one aspect of the invention, there is provided an LEV having multiple motors with different physical gear ratios (i.e. their efficiency curves peak at different vehicle speeds). In many cases, different classifications of motors are mixed with each motor assigned to perform a task they are best at. This gives an improvement in initial torque performance. However, the system still lacks the dynamic adjustability required for real world conditions. For example, on a 20 mph vehicle, two 500-watt motors may be geared such that motor one powers the vehicle to 13 mph when motor two takes over at 13 MPH and drives the LEV to 20 mph. Such configuration may function very well on a four degree slope. However, if the slope increases or the load is heavy, then motor two may have just enough power to barely maintain 14 mph, and motor one is under utilized. In this scenario, known motor controllers keep increasing amperage to motor two, resulting in significant energy losses.

In accordance with another aspect of the invention, there is provided an LEV measuring rider intent through throttle and brake position and rate of change for each. (i.e. when throttle is at the 100% position the rider wishes to continue to accelerate as quickly as possible to as high a speed as possible. When the throttle if feathered back to a lower setting, the rider is looking to maintain current speed or possibly reduce speed.) The rider intent is used as an input to control the motors.

In accordance with another aspect of the invention, there is provided an LEV distributing power between the motors so as to best meet the intent of the rider while optimizing the efficiency of the total system. For example, when climbing a steep hill, the rider may be at full throttle. However due to limitations in the size of the motors and capabilities of the power supply, continued acceleration may disproportionately affect efficiency or even damage vehicle components. This requires constant measurement of the state of each motor to gauge the efficiency of their operation.

In accordance with another aspect of the invention, there is provided an LEV providing dynamic allocation of power. The dynamic allocation of power allows vehicle speed to be adjusted down despite the vehicle's ability to maintain a higher speed. While at the same time, an override option is provided.

In accordance with yet another aspect of the invention, there is provided an LEV dynamically overlapping use of the motors under periods of heavy load is more efficient then other types of mechanical transmission LEVs. Other LEV approaches include either a single speed motor, or a motor fed into a transmission which can be set for one gear ratio at a time. Dynamically distributing power between motors which have different performance characteristics, allows continuously tuning the vehicle power utilization to the specific conditions of the road, thereby maximizing system efficiency.

In accordance with still another aspect of the invention, there is provided an LEV precisely controlling the power levels to at least two electric motors. By precisely controlling the power levels and distribution to the motors, components may be adapted to comply with jurisdictional regulatory requirements while delivering superior performance.

In accordance with yet another aspect of the invention, there is provided method for controlling a vehicle having at least two motors having different gear ratios and/or different motor performance characteristics. The method includes monitoring throttle position to determine desired performance, monitoring vehicle speed and rate of acceleration or deceleration to determine measured performance, monitoring running efficiency and rate of change of efficiency of each motor based on speed and/or current draw and/or temperature, comparing efficiencies of the two or more motors as a function of speed and load to determine efficiency ratios, inferring total vehicle efficiency by comparing the efficiency ratios to the motor performance characteristics, inferring vehicle load by comparing throttle position to measured performance to total vehicle efficiency, setting an efficiency variable for the efficiency ratio wherein minimum setting prioritizes efficiency and maximum prioritizes vehicle speed, based on the vehicle load and efficiency variable, dynamically adjusting the efficiency ratios using control options to most accurately meet the desired performances subject to total vehicle efficiency of the vehicle drive and variable setting, and based on the adjusted efficiency ratios, a controller continuously measuring and adjusting voltage and current to each of the motors.

### BRIEF DESCRIPTION OF THE DRAWING

The above and other aspects, features and advantages of the present invention will be more apparent from the following more particular description thereof, presented in conjunction with the following drawings wherein:

FIG. 1 shows the power and efficiency versus RPM of a typical Permanent Magnet Direct Current (PMDC) motor.

FIG. 2 shows a bicycle having two motors according to the present invention.

FIG. 3 shows a three or four wheel vehicle having two motors according to the present invention.

FIG. 4 shows a method according to the present invention.

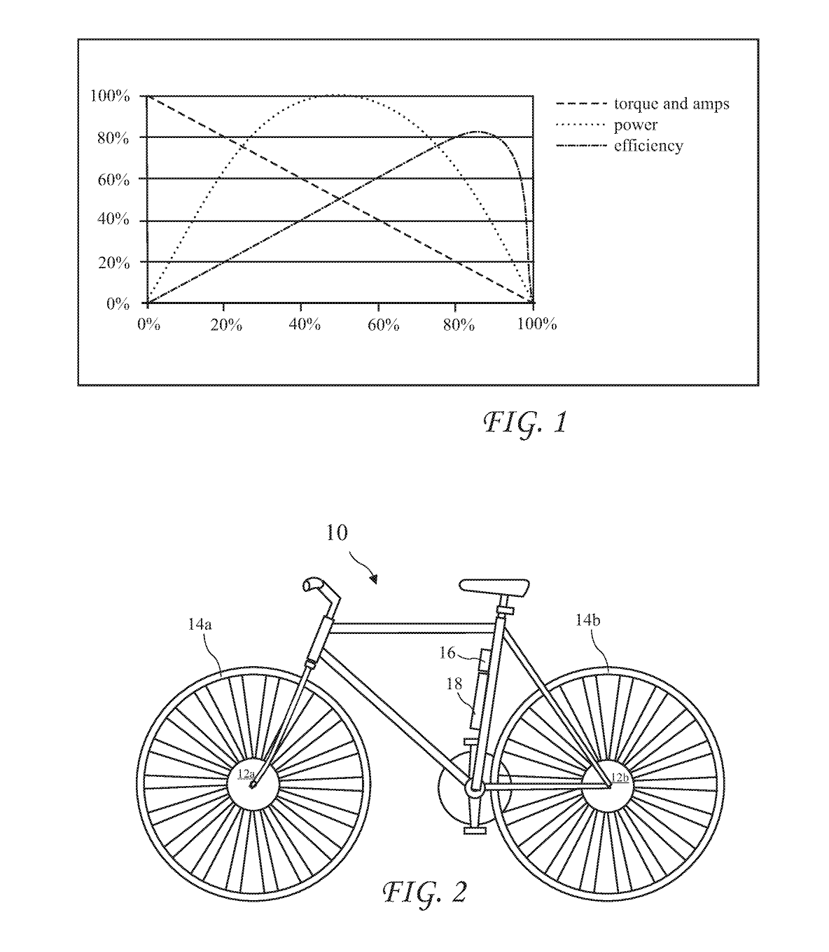

Corresponding reference characters indicate corresponding components throughout the several views of the drawings.

### BEST MODE FOR CARRYING OUT THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement. Either gear ratio or pulley/sprocket size differences are referred to as drive ratio and the method of the present invention is equally applicable to a motor couple to vehicle wheels through gear, belts, or chains.

### First Embodiment

FIG. 2 shows a bicycle 10 having 10 electric motors 12a and 12b (for example, hub motors), the first motor 12a driving a front wheel 12a, and a second motor 12b independently driving a rear wheel 12b. The two electric motors 12a and 12b allow for the rear motor 12b to be geared for more torque and lower speed (creating a “first gear”) and the front motor 12a to be geared for higher speed with greater efficiency (creating a “second gear”). A processor (or controller) 16 monitors rider inputs (for example, throttle position, pedal torque, brake application, etc.) and vehicle data (for example, motor efficiency and vehicle speed and acceleration) and determines how to most efficiently power the bicycle 10 using a battery 18 providing current and voltage to the motors 12a and 12b. The controller may further have stored efficiency versus RPM data for the motors 12a and 12b. Overlapping the motors 12a and 12b with different applications of primary power (both current and voltage) allocation allows for the bicycle 10 to maintain maximum efficiency no matter what the load or slope it must overcome. An additional benefit of this configuration is that it can be installed in a conventional bicycle frame design without any customization.

### Second Embodiment

Alternately, motors can be connected to the wheels or axles through gears, chains or belts. When separate motors provide torque to right and left wheels of a three or four wheeled vehicle, an additional software function is incorporated to blend power on start up so that the low speed wheel doesn't receive so much power that it begins to steer the vehicle.

### Third Embodiment

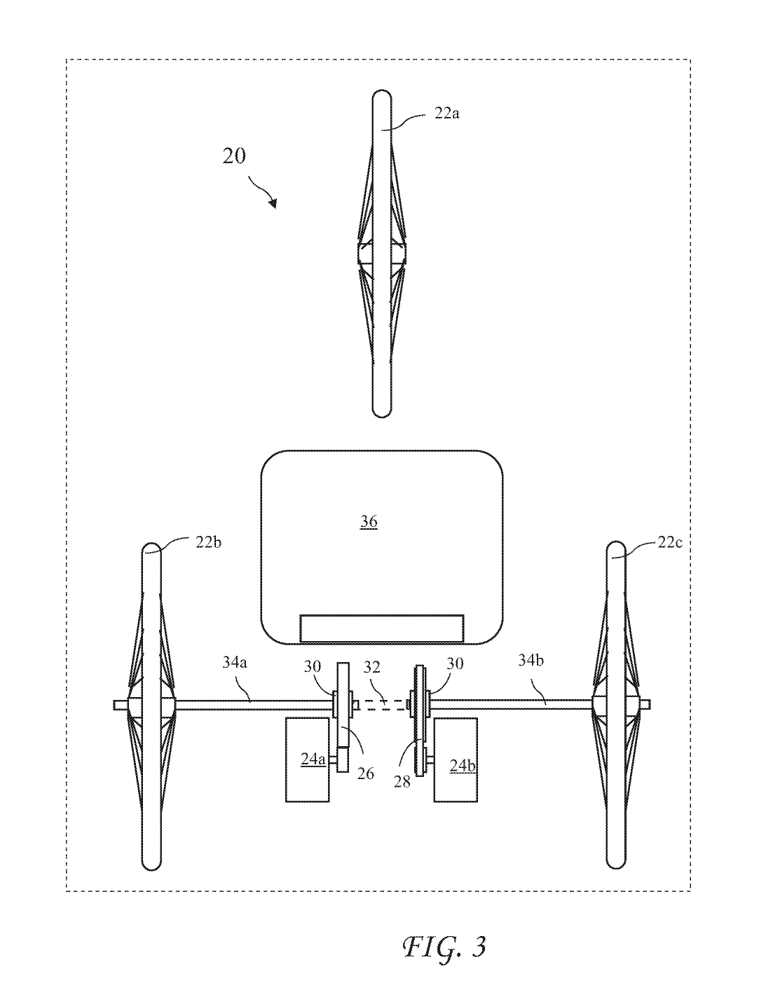

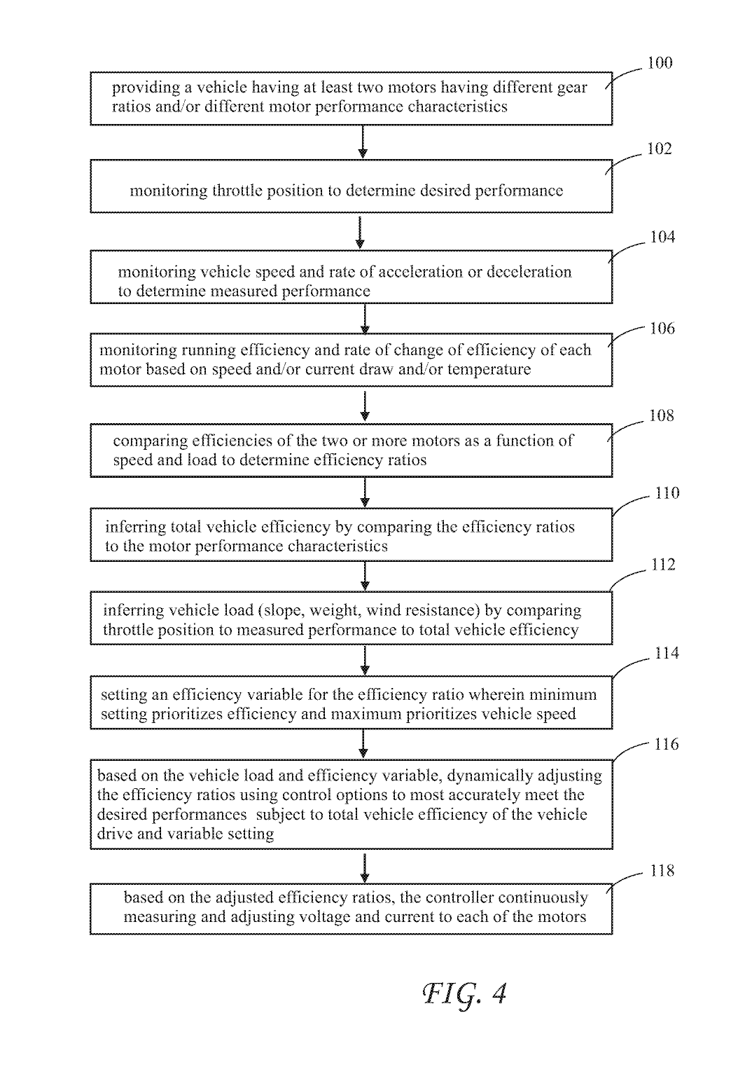

FIG. 3 shows a front or rear view of a three or four wheeled vehicle 20 having a seat 36, a front wheel 22a, and two motors 24a and 24b independently powering two independent wheels 22b and 22c. The motor 24a drives the wheel 22b through gears 26 and the motor 24b drives the wheel 22c through chain or belt 28. Sprague (or one way) clutches 30 may reside between the motors 24a and 24b and the axles 34a and 34b respectively to decouple a motor not providing torque to the wheels 22b and 22c. The motors 24a and 24b may be controlled as described for FIG. 2 to optimize efficiency.

A blend of the configurations may be used because the motor style used in the vehicle 20 may often generate low end torque more efficiently. Therefore some embodiments may have a “first gear” which is chain or belt driven and a “second gear” which is hub motor driven.

Additionally, for heavier applications, each wheel might have its own complete drive. That is, a wheel may be driven by one hub motor which has a secondary motor connected to it via a chain or belt. This gives the benefit of redundant drives in the event of a single component failure.

A method according to the present invention is shown in FIG. 4. The method includes providing a vehicle having at least two motors having different gear ratios and/or different motor performance characteristics at step 100, monitoring throttle position to determine desired performance at step 102, monitoring vehicle speed and rate of acceleration or deceleration to determine measured performance at step 104, monitoring running efficiency and rate of change of efficiency of each motor based on speed and/or current draw and/or temperature at step 106, comparing efficiencies of the two or more motors as a function of speed and load to determine efficiency ratios step 108, inferring total vehicle efficiency by comparing the efficiency ratios to the motor performance characteristics at step 110, inferring vehicle load by comparing throttle position to measured performance to total vehicle efficiency at step 112, setting an efficiency variable for the efficiency ratio wherein minimum setting prioritizes efficiency and maximum prioritizes vehicle speed at step 114, based on the vehicle load and efficiency variable, dynamically adjusting the efficiency ratios using control options to most accurately meet the desired performances subject to total vehicle efficiency of the vehicle drive and variable setting at step 116, and based on the adjusted efficiency ratios, the controller continuously measuring and adjusting voltage and current to each of the motors at step 118.

### INDUSTRIAL APPLICABILITY

The present invention finds industrial applicability in the field of electric vehicles.

### SCOPE OF THE INVENTION

While the invention herein disclosed has been described by means of specific embodiments and applications thereof, numerous modifications and variations could be made thereto by those skilled in the art without departing from the scope of the invention set forth in the claims.

I claim:

1. A Light Electric Vehicle (LEV), comprising:
first and second wheels providing propulsion;
a first electric motor coupled to drive the first wheel at a first speed versus efficiency curve;
a second electric motor coupled to dive the second wheel at a second speed versus efficiency curve different from the first speed versus efficiency curve, the second electric motor having a different drive ratio and/or different motor performance characteristics than the first electric motor; and
a processor configured to compute motor control signals for the first and second electric motors based on:
throttle position;
motor efficiency; and
vehicle speed and acceleration.

2. The LEV of claim 1, wherein at least one of the first electric motor and the second electric motor are connected to corresponding ones of the first and second wheels by gears.

3. The LEV of claim 1, wherein at least one of the first electric motor and the second electric motor are connected to corresponding ones of the first and second wheels by a belt.

4. The LEV of claim 1, wherein at least one of the first electric motor and the second electric motor are connected to corresponding ones of the first and second wheels by a chain.

5. The LEV of claim 1, wherein the motor control signals comprise voltage and current provided to each motor.

6. The LEV of claim 1, wherein the motor control signals further depend on an efficiency variable which prioritizes efficiency versus vehicle speed.

7. A method for controlling a Light Electric Vehicle (LEV) having at least two electric motors individually coupled to drive the LEV, the method comprising:
monitoring throttle position, motor efficiency, and vehicle speed and acceleration;
comparing efficiencies of the two or more motors as a function of speed and load to determine efficiency ratios; and
adjusting voltage and current to each of the electric motors based on the efficiency ratios to optimize performance.

8. The method of claim 7, further including:
setting an efficiency variable for the efficiency ratio wherein minimum setting prioritizes efficiency and maximum prioritizes vehicle speed; and
based on the vehicle load and efficiency variable, dynamically adjusting the efficiency ratios using control options to most accurately meet the desired performances subject to total vehicle efficiency of the vehicle drive and variable setting.

9. A method for controlling a Light Electric Vehicle (LEV), the method comprising:
providing a vehicle having at least two motors having different gear ratios and/or different motor performance characteristics;
monitoring throttle position to determine desired performance;
monitoring vehicle speed and rate of acceleration or deceleration to determine measured performance;
monitoring running efficiency and rate of change of efficiency of each motor based on speed and/or current draw and/or temperature;
comparing efficiencies of the two or more motors as a function of speed and load to determine efficiency ratios;
inferring total vehicle efficiency by comparing the efficiency ratios to the motor performance characteristics;
inferring vehicle load by comparing throttle position to measured performance to total vehicle efficiency;
setting an efficiency variable for the efficiency ratio wherein minimum setting prioritizes efficiency and maximum prioritizes vehicle speed;
based on the vehicle load and efficiency variable, dynamically adjusting the efficiency ratios using control options to most accurately meet the desired performances subject to total vehicle efficiency of the vehicle drive and variable setting; and
based on the adjusted efficiency ratios, a controller continuously measuring and adjusting voltage and current to each of the motors.
